(19) United States
(12) Patent Application Publication
(10) Pub. No.: US 2026/0034505 A1
(43) Pub. Date: Feb. 5, 2026

(54) METHODS FOR WATER HARVESTING

(71) Applicant: Saudi Arabian Oil Company, Dhahran (SA)

(72) Inventors: Wala Algozeeb, Al-Khobar (SA); Noha Al-Shihri, Al-Khobar (SA); Amer Tuwailib, Al Qatif (SA); Ibrahim Al-Zahrani, Dammam (SA); Hassan Al Tarouti, Al Qatif (SA)

(21) Appl. No.: 18/788,654

(22) Filed: Jul. 30, 2024

(51) Int. Cl. B01D 53/26; B01D 53/04; B01J 20/20; B01J 20/28; B01J 20/30; B01J 20/34; E03B 3/28

(52) U.S. Cl. CPC B01D 53/261; B01D 53/0438; B01J 20/20; B01J 20/28059; B01J 20/28061; B01J 20/28064; B01J 20/3071; B01J 20/3078; B01J 20/3416; B01J 20/3441; E03B 3/28; B01D 2253/102; B01D 2253/308; B01D 2257/80; B01D 2259/40083; B01D 2259/40088

(57) ABSTRACT

A method for harvesting water includes contacting a nanoporous carbon (NPC) material with a stream of humid atmospheric air, thereby at least partially absorbing water in the form of molecules on surfaces and pores of the NPC material to form a sample, releasing the water from the sample by thermally heating the sample or exposing the sample to ultraviolet-visible (UV-Vis) radiation; and collecting the water. A method of making the NPC material by calcining one or more petroleum feedstocks is also disclosed.

### TECHNICAL FIELD

The present disclosure relates to methods for water harvesting, more particularly, to methods for harvesting water using petroleum derived porous carbon. The present disclosure also relates to methods of making the petroleum derived porous carbon.

### BACKGROUND

Water harvesting using a sorbent involves capturing water from air and releasing the water from the sorbent for consumption. Due to the abundance of atmospheric water present in the air, this method could help alleviate global water scarcity. Traditionally, metal organic frameworks (MOFs) and covalent organic frameworks (COFs) have been explored as sorbents for water harvesting. However, both MOFs and COFs are expensive and unstable due to their physical and chemical properties. Accordingly, there is a need to develop alternative sorbent materials that are stable, cost effective, and have enhanced water capacity. Additionally, there is also a need to develop more efficient methods for water harvesting.

### SUMMARY

This disclosure describes technologies relating to methods for water harvesting, and methods of making petroleum derived porous carbon.

### BRIEF DESCRIPTION OF THE DRAWINGS

FIG. 1 is a schematic diagram illustrating the preparation of a nanoporous carbon (NPC) material, according to certain embodiments of the present disclosure.

FIG. 2A is a plot of a thermogravimetric analysis (TGA) curve of various petroleum feedstocks, according to certain embodiments of the present disclosure.

FIG. 2B is a plot of fix carbon content of various carbon-containing feedstocks including petroleum feedstocks and biomasses, according to certain embodiments of the present disclosure.

FIG. 2C is a plot of carbon number distributions of various petroleum feedstocks, according to certain embodiments of the present disclosure.

FIG. 2D is a plot of double bond equivalent (DBE) values of various petroleum feedstocks, according to certain embodiments of the present disclosure.

FIG. 3A is a plot of a TGA curve of the NPC material tested in air and nitrogen conditions, according to certain embodiments of the present disclosure.

FIG. 3B is an X-ray diffraction (XRD) profile of the NPC material, according to certain embodiments of the present disclosure.

FIG. 3C is a Raman spectrum of the NPC material, according to certain embodiments of the present disclosure.

FIG. 3D is a scanning electron microscope (SEM) image of the NPC material showing a porous structure, according to certain embodiments of the present disclosure.

FIG. 4A is an image of water contact angle measurements of a water droplet before contacting with the NPC material, according to certain embodiments of the present disclosure.

FIG. 4B is an image of water contact angle measurements of a water droplet after contacting with the NPC material, according to certain embodiments of the present disclosure.

FIG. 4C illustrates an energy-dispersive X-ray (EDX) analysis of the NPC material, according to certain embodiments of the present disclosure.

FIG. 5A is a diagrammatic illustration depicting the setup of a water harvesting test, according to certain embodiments of the present disclosure.

FIG. 5B is a Fourier Transform Infrared Spectroscopy (FTIR) analysis of the NPC materials, such as light cycle oil carbon (LCOC), heavy cycle oil carbon (HCOC), vacuum residue carbon (VRC), Arab light crude oil carbon (ARC), and dry carbon, before and after water adsorption, according to certain embodiments of the present disclosure.

FIG. 5C is a plot of water uptake capacity of various NPC materials, according to certain embodiments of the present disclosure.

FIG. 5D is a temperature programmed desorption (TPD) profile of various adsorbed molecules from the NPC material, according to certain embodiments of the present disclosure.

### DETAILED DESCRIPTION

In view of the foregoing, one objective of the present disclosure is to provide a method for harvesting water using a nanoporous carbon (NPC) material. A second objective of the present disclosure is to provide a method for preparing the NPC material.

Provided in the present disclosure are methods for harvesting water using solid sorbents, such as porous carbon derived from petroleum feeds. These porous carbon sorbents are produced in large quantities with improved stability compared to MOFs and COFs. Furthermore, the porous carbon of the present disclosure can be easily packaged, stored, and transported.

The method for harvesting water includes contacting a nanoporous carbon (NPC) material with a stream of humid atmospheric air, thereby at least partially absorbing water in the form of molecules on surfaces and pores of the NPC material to form a sample. In some embodiments, the NPC material is in contact with the stream at ambient conditions of room temperature and atmospheric pressure. In some embodiments, the NPC material is in contact with the stream for about 30 minutes to about 14 days, such as about 1 hour to about 12 days, about 3 hours to about 10 days, about 5 hours to about 8 days, about 7 hours to about 6 days, about 9 hours to about 4 days, about 11 hours to about 2 days, about 13 hours to about 1 day, about 15 hours to about 18 hours, or about 30 minutes, about 4 hours, about 8 hours, about 12 hours, about 16 hours, about 16 hours, about 20 hours, about 24 hours, about 2 days, about 5 days, about 8 days, about 11 days, or about 14 days.

In some embodiments, the stream of humid atmospheric air has a relative humidity (RH) of about 15 to about 80% based on a maximum pressure of water vapor present in the humid atmospheric air, such as about 20 to about 75%, about 25 to about 70%, about 30 to about 65%, about 35 to about 60%, about 40 to about 55%, about 45 to about 50%, or about 15%, about 25%, about 35%, about 45%, about 55%, about 65%, or about 75%. In some embodiments, the stream of humid atmospheric air has a RH of about 20% based on the maximum pressure of water vapor present in the humid atmospheric air. In further embodiments, the stream of humid atmospheric air has a RH of about 30% based on the maximum pressure of water vapor present in the humid atmospheric air. In further embodiments, the stream of humid atmospheric air has a RH of about 40% based on the maximum pressure of water vapor present in the humid atmospheric air. In further embodiments, the stream of humid atmospheric air has a RH of about 50% based on the maximum pressure of water vapor present in the humid atmospheric air. In further embodiments, the stream of humid atmospheric air has a RH of about 60% based on the maximum pressure of water vapor present in the humid atmospheric air. In further embodiments, the stream of humid atmospheric air has a RH of about 70% based on the maximum pressure of water vapor present in the humid atmospheric air.

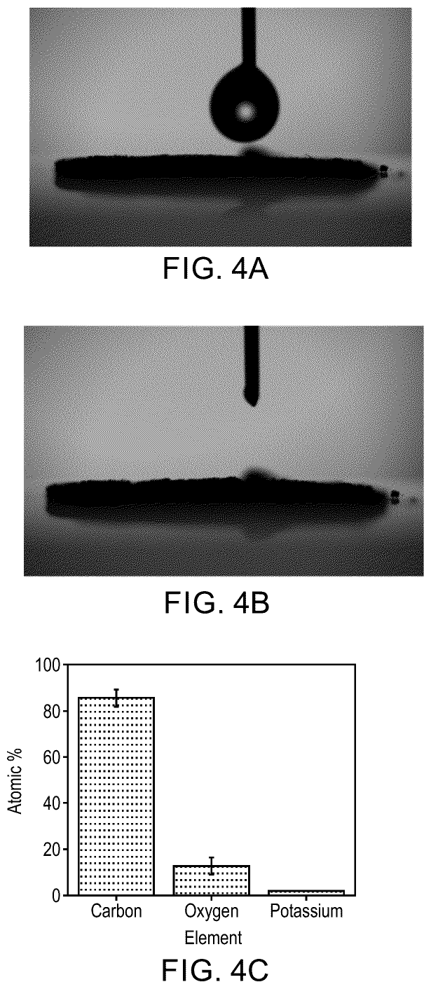

In some embodiments, the NPC material contains about 70 to about 90 wt. % of carbon, about 2 to about 20 wt. % of oxygen, and about 0.001 to about 7 wt. % of one or more alkali metals and alkali earth metals. The element content of the NPC material is determined by energy-dispersive X-ray (EDX) analysis, as depicted in FIG. 4C. In some embodiments, the EDX analysis is conducted by applying an NPC material on a copper-covered stump to form a copper-covered sample. The copper-covered sample is used to ensure proper analysis and high quality, and the image is magnified a million times.

In some embodiments, the NPC material contains about 70 to about 90 wt. % of carbon, such as about 72 to about 88 wt. % of carbon, about 74 to about 86 wt. % of carbon, about 76 to about 84 wt. % of carbon, about 78 to about 82 wt. % of carbon, or about 73 wt. % of carbon, about 76 wt. % of carbon, about 79 wt. % of carbon, about 82 wt. % of carbon, about 85 wt. % of carbon, or about 88 wt. % of carbon, as determined by EDX analysis. In some embodiments, the NPC material contains about 2 to about 20 wt. % of oxygen, such as about 4 to about 18 wt. % of oxygen, about 6 to about 16 wt. % of oxygen, about 8 to about 14 wt. % of oxygen, about 10 to about 12 wt. % of oxygen, or about 3 wt. % of oxygen, about 6 wt. % of oxygen, about 9 wt. % of oxygen, about 12 wt. % of oxygen, about 15 wt. % of oxygen, or about 18 wt. % of oxygen, as determined by EDX analysis. In some embodiments, the NPC material contains about 0.001 to about 7 wt. % of one or more alkali metals and alkali earth metals, such as about 0.01 to about 6 wt. % of one or more alkali metals and alkali earth metals, about 0.1 to about 5 wt. % of one or more alkali metals and alkali earth metals, about 0.5 to about 4 wt. % of one or more alkali metals and alkali earth metals, about 1 to about 3 wt. % of one or more alkali metals and alkali earth metals, or about 0.05 wt. % of one or more alkali metals and alkali earth metals, about 0.5 wt. % of one or more alkali metals and alkali earth metals, about 1.5 wt. % of one or more alkali metals and alkali earth metals, about 2.5 wt. % of one or more alkali metals and alkali earth metals, about 3.5 wt. % of one or more alkali metals and alkali earth metals, or about 4.5 wt. % of one or more alkali metals and alkali earth metals, as determined by EDX analysis.

In some embodiments, the one or more alkali metals and alkali earth metals are selected from the group consisting of lithium, sodium, potassium, rubidium, cesium, francium, beryllium, magnesium, calcium, strontium, barium, radium, and mixtures thereof. In further embodiments, the one or more alkali metals and alkali earth metals are potassium, sodium, and calcium. In further embodiments, the one or more alkali metals and alkali earth metals are potassium.

In some embodiments, the NPC material contains about 70 to about 90 wt. % of carbon, such as about 72 to about 88 wt. % of carbon, about 74 to about 86 wt. % of carbon, about 76 to about 84 wt. % of carbon, about 78 to about 82 wt. % of carbon, or about 73 wt. % of carbon, about 76 wt. % of carbon, about 79 wt. % of carbon, about 82 wt. % of carbon, about 85 wt. % of carbon, or about 88 wt. % of carbon; about 2 to about 20 wt. % of oxygen, such as about 4 to about 18 wt. % of oxygen, about 6 to about 16 wt. % of oxygen, about 8 to about 14 wt. % of oxygen, about 10 to about 12 wt. % of oxygen, or about 3 wt. % of oxygen, about 6 wt. % of oxygen, about 9 wt. % of oxygen, about 12 wt. % of oxygen, about 15 wt. % of oxygen, or about 18 wt. % of oxygen; and about 0.001 to about 7 wt. % of potassium, such as about 0.01 to about 6 wt. % of potassium, about 0.1 to about 5 wt. % of potassium, about 0.5 to about 4 wt. % of potassium, about 1 to about 3 wt. % of potassium, or about 0.05 wt. % of potassium, about 0.5 wt. % of potassium, about 1.5 wt. % of potassium, about 2.5 wt. % of potassium, about 3.5 wt. % potassium, or about 4.5 wt. % of potassium. In further embodiments, the NPC material contains about 80 to about 90 wt. % of carbon, about 10 to about 18 wt. % of oxygen, and about 0.1 to about 2 wt. % of potassium. In further embodiments, the NPC material contains about 84 to about 86 wt. % of carbon, about 14 to about 16 wt. % of oxygen, and about 0.3 to about 1 wt. % of potassium. In further embodiments, the NPC material contains about 85.5 wt. % of carbon, about 14 wt. % of oxygen, and about 0.5 wt. % of potassium.

The wetting properties of the NPC material are examined. One measure for surface hydrophilicity/hydrophobicity is the droplet contact angle of a liquid; common and exemplary liquids include, but are not limited to, water, glycerol, and diiodomethane. Referring to FIGS. 4A and 4B, the water contact angle was obtained by the sessile drop method on surfaces of the NPC material by using a contact angle goniometer instrument, e.g., DSA25, Denmark. The water contact angle (WCA) is taken on at least two, such as at least four different positions on the material tested and the average value is recorded.

FIG. 4A shows a water droplet before contacting with the NPC material. The water droplet remains intact before contacting with the NPC material. In some embodiments, the WCA of the water droplet on a surface of the NPC material is in a range of about 0 to about 10°, such as about 0 to about 8°, about 0 to about 6°, about 0 to about 4°, about 0 to about 2°, or about 0 to about 1°, or about 7°, about 6°, about 5°, about 4°, about 3°, about 2°, about 1°, or about 0°, as depicted in FIG. 4B. In further embodiments, the NPC material has a water contact angle of less than about 2°. In further embodiments, the NPC material has a water contact angle of less than about 1°. In further embodiments, the NPC material has a water contact angle of about 0°.

In some embodiments, the NPC material has a water uptake capacity of about 3 to about 50 wt. % of the NPC material.

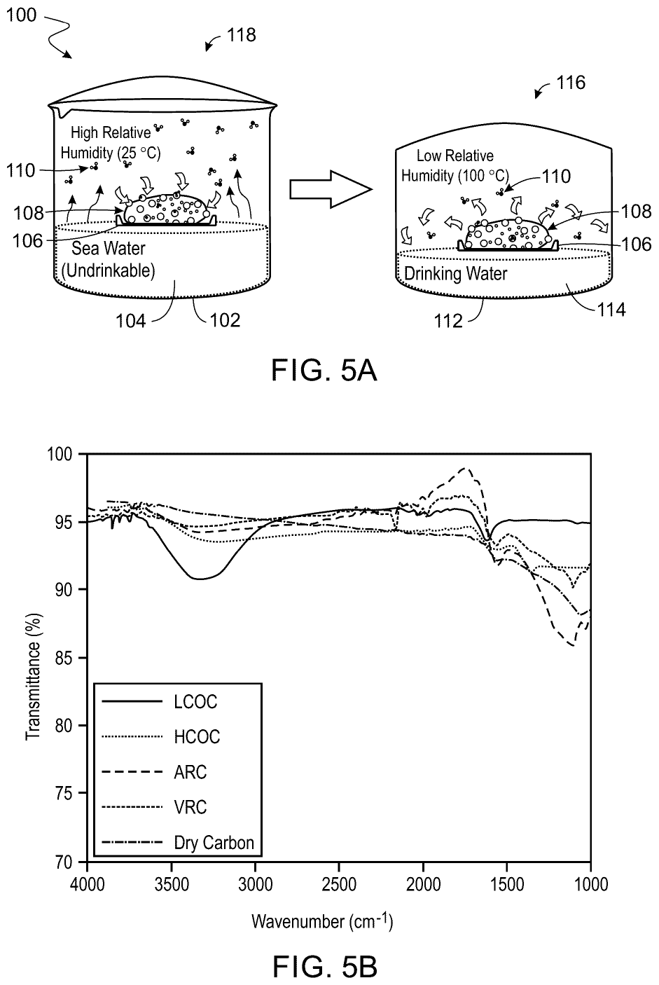

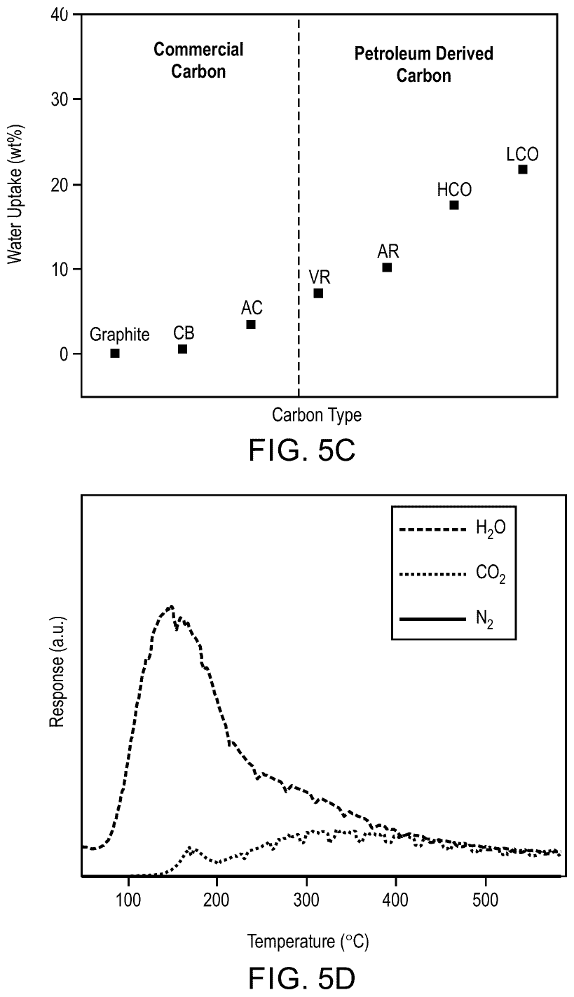

Referring to FIG. 5A, the setup (100) of a water harvesting test is carried out at ambient conditions of room temperature and atmospheric pressure. The setup includes a first container (102) having a first lid -(118), an aqueous solution (104), a tray (106) having a substantially flat surface, the NPC material (108) in the form of dry powder. In some embodiments, the NPC material (108) is evenly distributed over the substantially flat surface of the tray (106). In some embodiments, the tray (106) is configured to avoid the NPC material (108) from directly contacting with the aqueous solution (104), and is placed above a surface of the aqueous solution (104) and within the first container (102). In some embodiments, the first lid (118) is configured to be removably coupled to the first container (102) for concealing the contents of the first container (102). In some embodiments, the aqueous solution (104) contains one or more salts selected from the group consisting of sodium chloride, magnesium chloride, sodium bromide, magnesium bromide, calcium chloride, calcium bromide, and combinations thereof. In some embodiments, the aqueous solution contains at least one of a water, a brine, a produced water, a flowback water, a brackish water, an Arab-D-brine, sea water, and combinations thereof. In some embodiments, the aqueous solution (104) provides a humid atmospheric air within the first container (102). In some embodiments, the humid atmospheric air has a relative humidity (RH) of about 15 to about 80% based on a maximum pressure of water vapor present in the humid atmospheric air, such as about 20 to about 75%, about 25 to about 70%, about 30 to about 65%, about 35 to about 60%, about 40 to about 55%, about 45 to about 50%, or about 15%, about 25%, about 35%, about 45%, about 55%, about 65%, or about 75%. The water molecules (110) originated from the aqueous solution (104) are absorbed on surfaces and pores of the NPC material (108). In some embodiments, the NPC material (108) supported on the tray (106) is placed in the container (102) for about 30 minutes to about 14 days, such as about 1 hour to about 12 days, about 3 hours to about 10 days, about 5 hours to about 8 days, about 7 hours to about 6 days, about 9 hours to about 4 days, about 11 hours to about 2 days, about 13 hours to about 1 day, about 15 hours to about 18 hours, or about 30 minutes, about 4 hours, about 8 hours, about 12 hours, about 16 hours, about 16 hours, about 20 hours, about 24 hours, about 2 days, about 5 days, about 8 days, about 11 days, or about 14 days.

Also referring to FIG. 5A, the setup (100) of a water harvesting test further includes a second container (112) having a second lid (116). In some embodiments, the second container (112) is a transparent container. In some embodiments, the second container (112) is a heat conductive container. In some embodiments, the second lid (116) is configured to be removably coupled to the second container (112) for concealing the contents of the second container (112). After completion of the absorption, the NPC material (108) along with the tray (106) is transferred into the second container (112) followed by closing the second lid (116), thereby the NPC material (108) has no mass communication with the outside environment. In some embodiments, the NPC material (108) is in heat communication with a heat source configured to release the absorbed water molecules from the NPC material (108), thereby forming a water residue (114) in the bottom of the second container (112). In some embodiments, the NPC material (108) is in light communication with a light source configured to release the absorbed water molecules from the NPC material (108), thereby forming the water residue (114) in the bottom of the second container (112). The light source may be an ultraviolet light source from an excimer lamp having a center wavelength in a wavelength range of 150 to about 600 nm, such as about 160 to about 500 nm, about 170 to about 400 nm, about 180 to about 300 nm, or about 190 to about 250 nm.

The water uptake capacity is determined by Equation 1,

$$Water Uptake Capacity = \frac{{m}_{wet} - {m}_{dry}}{{m}_{dry}} \times 100 \% \qquad ( Eq 1 )$$

in which, m_{wet} is the mass of the NPC material after water absorption, while m_{dry} is the initial mass of the NPC material in dry powders.

In some embodiments, the NPC material has a water uptake capacity of about 3 to about 50 wt. % of the NPC material, such as about 8 to about 45 wt. %, about 11 to about 40 wt. %, about 14 to about 40 wt. %, about 17 to about 35 wt. %, about 20 to about 30 wt. %, or about 25 wt. %. In some embodiments, the NPC material has a water uptake capacity of about 22 wt. %.

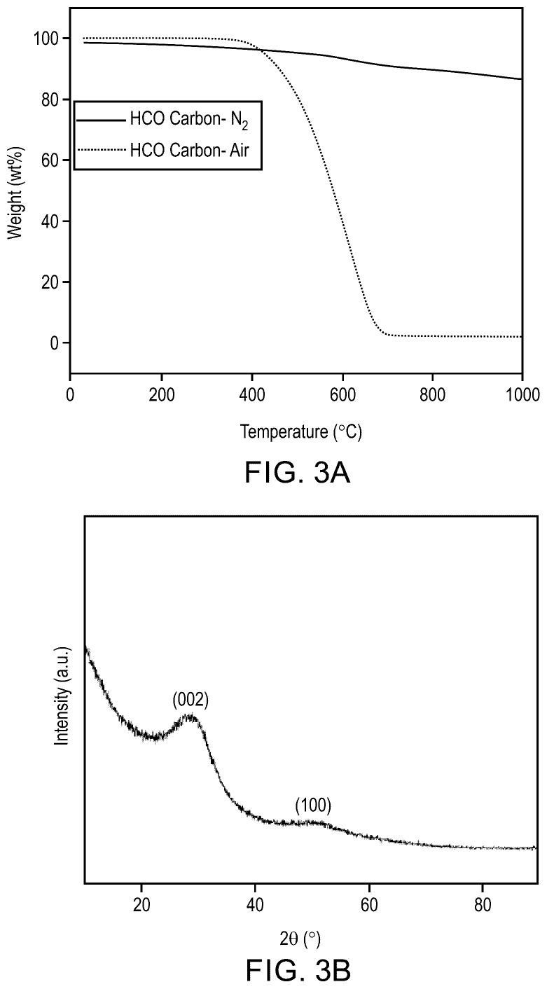

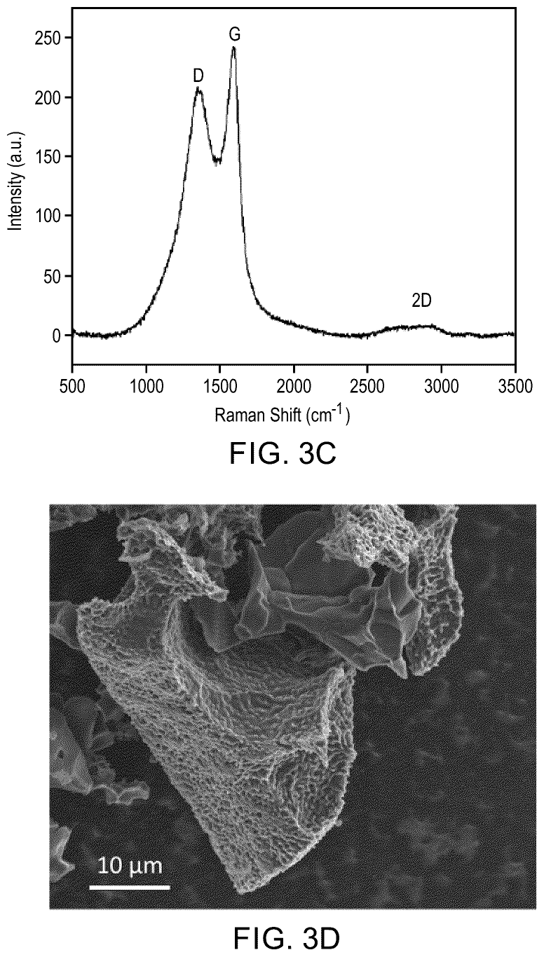

In some embodiments, the NPC material has an average pore size of about 50 nanometers (nm) to about 1000 nm, such as about 100 to about 950 nm, about 150 to about 900 nm, about 200 to about 850 nm, about 250 to about 800 nm, about 300 to about 750 nm, about 350 to about 700 nm, about 400 to about 650 nm, about 450 to about 600 nm, or about 500 to about 550 nm, as depicted in FIG. 3D. In some embodiments, the NPC material has an average pore size of about 80 nm, about 150 nm, about 220 nm, about 290 nm, about 360 nm, about 430 nm, about 500 nm, about 570 nm, about 640 nm, about 710 nm, about 780 nm, about 860 nm, or about 930 nm. In some embodiments, the pores on surfaces of the NPC material have a substantially uniform shape, substantially uniform size and/or substantially uniform distribution across the surfaces.

In some embodiments, the NPC material contains a sponge-like uniform shape structure including at least one of the following properties, such as porous, absorbent, and/or compressible. In some embodiments, the sponge-like structure of the NPC material has an average thickness of about 5 to 30 micrometers (μm), such as about 7 to about 28 μm, about 9 to about 26 μm, about 11 to about 24 μm, about 13 to about 22 μm, about 15 to about 20 μm, or about 17 to about 18 μm. In some embodiments, the NPC material also contains a non-uniform protrusion, as depicted in FIG. 3D.

The structure of the NPC material is characterized by X-ray diffraction (XRD). In some embodiments, the XRD patterns are collected in a Rigaku diffractometer (Miniflex) equipped with a Cu-Kα radiation source (λ=0.15406 nm) for a 20 range extending between about 5° and about 90°, such as about 10° and about 80°, about 20° and about 70°, about 30° and about 60°, about 40° and about 50°, at an angular rate of about 0.005 to about 0.04°/s, about 0.01 to about 0.03°/s, or about 0.02°/s. In further embodiments, the XRD patterns are collected over a 2θ range extending between about 5° and about 90° at an angular rate of about 0.02°/s.

FIG. 3B depicts XRD patterns of the NPC material. In some embodiments, the NPC material has a first intense peak with a 2 theta (θ) value in a range of about 20° to about 30°, such as about 23° to about 29°, or about 28° corresponding to the (002) lattice plane of the porous structure of the NPC material. In some embodiments the NPC material has a second intense peak with a 2θ value in a range of about 40° to about 60°, such as about 45° to about 55°, or about 50° corresponding to the (100) lattice plane of the porous structure of the NPC material.

The structure of the NPC material is characterized by Raman spectroscopy as depicted in FIG. 3C. In some embodiments, the NPC material has a first intense peak in a range of about 1000 to about 1500 cm⁻¹, such as about 1100 to about 1400 cm⁻¹, or about 1200 to about 1300 cm⁻¹ corresponding to the D band of the porous NPC material; a second intense peak in a range of about 1500 to about 1900 cm⁻¹, such as about 1550 to about 1800 cm⁻¹, or about 1600 to about 1700 cm⁻¹ corresponding to the G band of the porous NPC material; a third intense peak in a range of about 2500 to about 3100 cm⁻¹, such as about 2700 to about 3000 cm⁻¹, or about 2800 to about 2900 cm⁻¹ corresponding to the 2D band of the porous NPC material.

FIG. 3A depicts TGA curves of the NPC material under air and nitrogen. In some embodiments, the NPC material has a weight loss of less than about 10 wt. %, such as less than about 8 wt. %, less than about 6 wt. %, less than about 4 wt. %, less than about 2 wt. %, or less than about 1 wt. % of the NPC material in an inert (i.e., nitrogen) atmosphere at a temperature of about 600° C. In some embodiments, the NPC material has a weight loss of about 40 to about 90 wt. %, such as about 45 to about 85 wt. %, about 50 to about 80 wt. %, about 55 to about 75 wt. %, about 60 to about 70 wt. %, or about 65 wt. % of the NPC material in an oxygen atmosphere at a temperature of about 600° C.

The method also includes releasing the water from the sample by thermally heating the sample or exposing the sample to ultraviolet-visible (UV-Vis) radiation. In some embodiments, the water is released from the sample by thermally heating. In some embodiments, the thermally heating the sample is carried out at a temperature of about 30 to about 600° C., such as about 60 to about 550° C., about 90 to about 500° C., about 120 to about 450° C., about 150 to about 400° C., about 180 to about 350° C., about 210 to about 300° C., or about 240 to about 250° C. In some embodiments, the water is released from the sample by exposing the sample to UV-Vis radiation. In some embodiments, the exposing the sample to UV-Vis radiation is carried out at a wavelength of about 150 to about 600 nm, such as about 200 to about 550 nm, about 250 to about 500 nm, about 300 to about 450 nm, or about 350 to about 400 nm, or about 180 nm, about 210 nm, about 240 nm, about 270 nm, about 300 nm, about 330 nm, about 360 nm, about 390 nm, about 420 nm, about 450 nm, about 480 nm, about 510 nm, about 540 nm, or about 570 nm.

Referring to FIG. 5D, the temperature program desorption (TPD) test is performed on the NPC material using water (H₂O), carbon dioxide (CO₂), and nitrogen (N₂) molecules, respectively. In some embodiments, the H₂O-TPD curve shows the NPC material has a weight loss of water at a temperature of about 50 to about 450° C., such as about 60 to about 400° C., about 70 to about 350° C., about 80 to about 300° C., about 90 to about 250° C., about 100 to about 200° C., or about 110 to about 150° C. In some embodiments, the sample has a maximum weight loss of water at a 25 temperature of about 150° C. as determined by the TPD method.

The structure of the NPC material is characterized by the Fourier transform infrared spectra (FTIR) as depicted in FIG. 5B. FTIR spectrum of the NPC material is studied by using Fourier transform infrared spectra (Nicolet 170 IR spectrometer). For the Fourier transform infrared spectra characterization, the KBr discs of the samples are prepared by mixing and grounding the NPC material with KBr powder in mortar with pestle. The mixture is then shaped into discs under mechanical pressure. The sample discs are put into Fourier transform infrared spectra and spectral measurements are recorded in the wavenumber range of about 450 to about 4000 cm⁻¹. Prior to the above measurement, the samples are vacuum-dried at about 60° C. for a duration of about 24 hours.

In some embodiments, the NPC material after water adsorption has a first intense peak in a range of about 1220 to about 1400 cm⁻¹, such as about 1270 to about 1350 cm⁻¹, or about 1300 cm⁻¹; a second intense peak in a range of about 1400 to about 1750 cm⁻¹, such as about 1450 to about 1700 cm⁻¹, or about 1550 cm⁻¹; a third intense peak in a range of about 3000 to about 3600 cm⁻¹, such as about 3200 to about 3400 cm⁻¹, or about 3300 cm⁻¹.

Also provided in the present disclosure is a method of preparing the NPC material. The method of preparing the NPC material includes mixing the one or more petroleum feedstocks and one or more metal salts to form a mixture.

In some embodiments, the one or more petroleum feedstocks include, but are not limited to, a pyrolysis oil, a light cycle oil, a heavy cycle oil, a high sulfur containing residue, a vacuum residue, an Arab light crude oil, an Arab extra light crude oil.

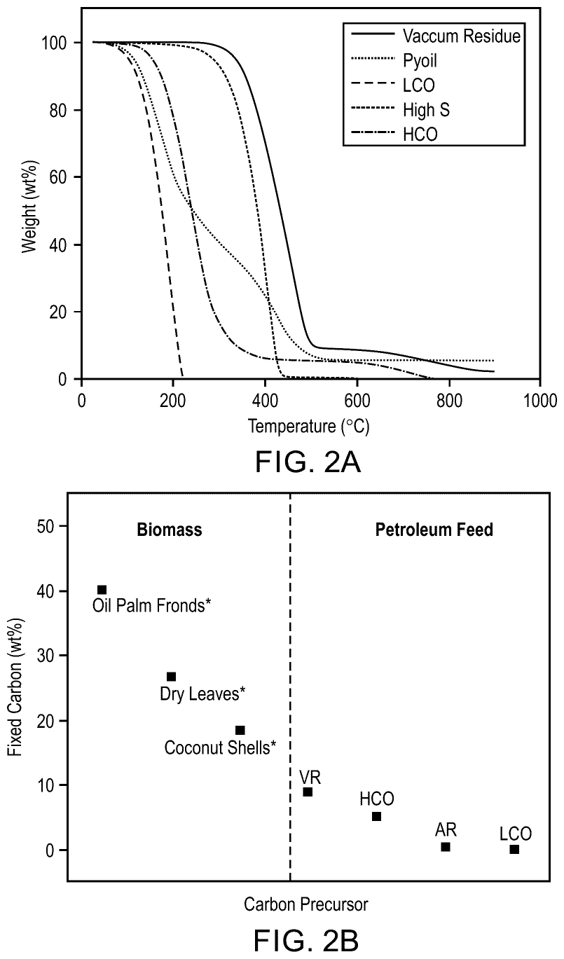

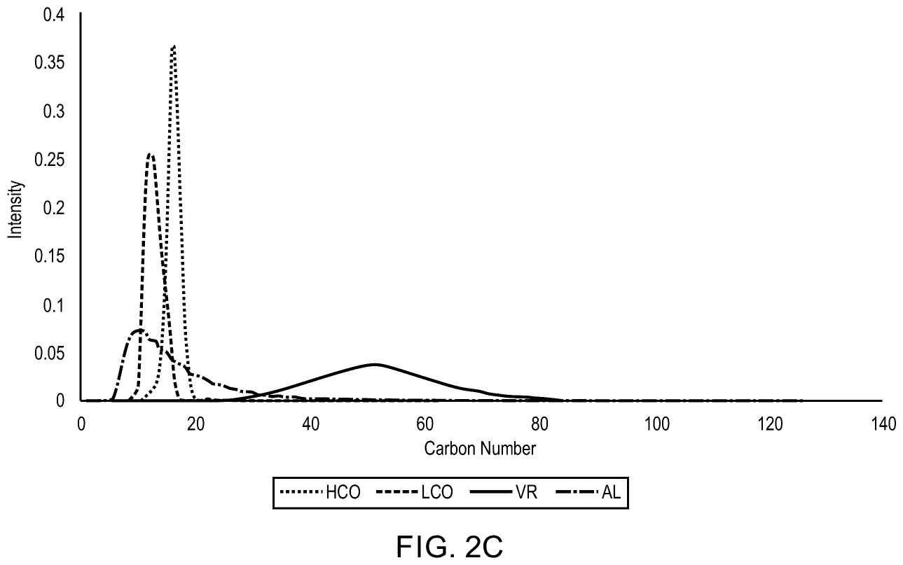

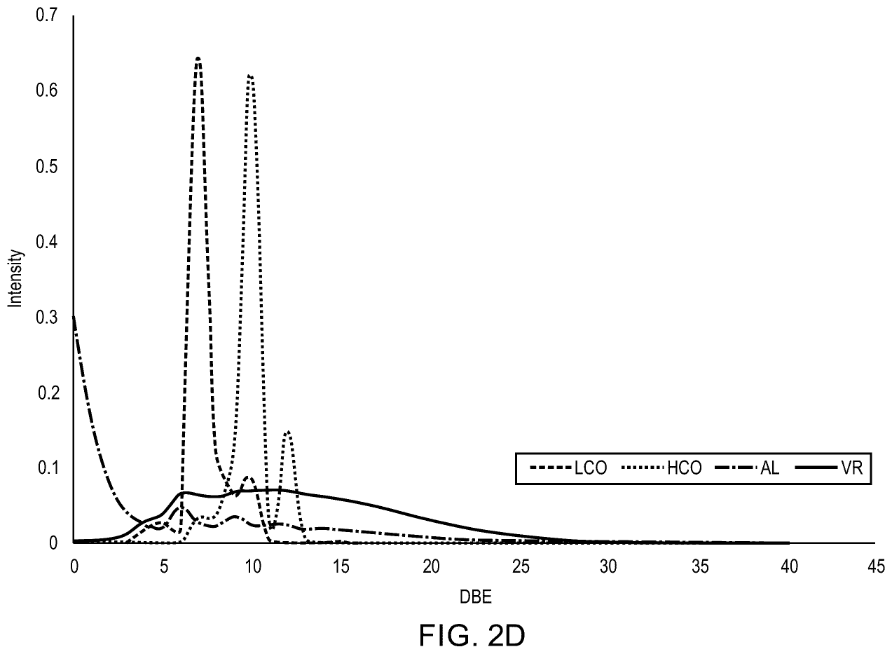

In some embodiments, the pyrolysis oil (pyoil) has a weight loss of about 30 to 60 wt. %, such as about 35 to about 55 wt. %, about 40 to about 50 wt. %, or about 45 wt. % at a temperature of about 200 to 300° C., such as about 225 to about 275° C., or about 250° C., as determined by thermogravimetric analysis (TGA) and depicted in FIG. 2A. In some embodiments, the pyrolysis oil has a weight loss of about 50 to 95 wt. %, such as about 60 to about 90 wt. %, about 70 to about 85 wt. %, or about 85 wt. % at a temperature of about 300 to 800° C., such as about 500 to about 600° C., or about 550° C., as determined by TGA and depicted in FIG. 2A. The pyrolysis oil is a feed produced from waste streams including plastic waste.

In some embodiments, the light cycle oil (LCO) has a weight loss of about 90 to 99 wt. %, such as about 92 to about 99 wt. %, about 94 to about 99 wt. %, or about 99 wt. % at a temperature of about 180 to 300° C., such as about 200 to about 250° C., or about 220° C., as determined by TGA and depicted in FIG. 2A. The LCO is a light fraction produced from the fluid catalytic cracker (FCC) reactor that keeps cycling without reaction. In some embodiments, the LCO has a specific gravity of about 0.94 to about 0.96, such as about 0.942 to about 0.958, about 0.944 to about 0.956, about 0.946 to about 0.954, about 0.948 to about 0.952, or about 0.950. In some embodiments, the LCO has a specific gravity of about 0.950. In some embodiments, the LCO has a carbon content of about 0.1 to about 8 wt. %, such as about 0.3 to about 6 wt. %, about 0.5 to about 4 wt. %, about 0.7 to about 2 wt. %, or about 0.9 to 1 wt. %, based on the total weight of the LCO, as depicted in FIG. 2B. In some embodiments, the LCO has a carbon number of about 10 to about 22, such as about 12 to about 20, about 14 to about 18, or about 16, as depicted in FIG. 2C. In some embodiments, the LCO has a double bond equivalent (DBE) value of about 5 to 12, such as about 6 to about 11, about 7 to about 10, or about 8 to about 9, as depicted in FIG. 2D.

In some embodiments, the heavy cycle oil (HCO) has a weight loss of about 80 to 95 wt. %, such as about 85 to about 95 wt. %, about 90 to about 95 wt. %, or about 90 wt. % at a temperature of about 300 to 600° C., such as about 350 to about 500° C., or about 400° C., as determined by TGA and depicted in FIG. 2A. The HCO is an intermediate fraction produced from the fluid catalytic cracker (FCC) that is high in aromatic content. In some embodiments, the HCO has a specific gravity of about 1.00 to about 1.02, such as about 1.002 to about 1.018, about 1.004 to about 1.016, about 1.006 to about 1.014, about 1.008 to about 1.012, or about 1.01. In some embodiments, the HCO has a specific gravity of about 1.01. In some embodiments, the HCO has a carbon content of about 1 to about 9 wt. %, such as about 3 to about 8 wt. %, about 5 to about 7 wt. %, about 6 to about 7 wt. %, or about 6.5 wt. %, based on the total weight of the HCO, as depicted in FIG. 2B. In some embodiments, the HCO has a carbon number of about 10 to about 24, such as about 12 to about 23, about 14 to about 22, about 16 to about 21, or about 17 to about 20, as depicted in FIG. 2C. In some embodiments, the HCO has a DBE value of about 4 to 16, such as about 6 to about 15, about 8 to about 14, or about 10 to about 13, as depicted in FIG. 2D.

In some embodiments, the high sulfur containing residue (High S) has a weight loss of about 90 to 99 wt. %, such as about 92 to about 99 wt. %, about 94 to about 99 wt. %, or about 99 wt. % at a temperature of about 400 to 600° C., such as about 450 to about 550° C., or about 500° C., as determined by TGA and depicted in FIG. 2A. High S is a residual feed from refinery at atmospheric pressure. This usually contain large amounts of S. In some embodiments, the High S has a sulfur content of about 0.6 to about 8 wt. %, such as about 1 to about 7 wt. %, about 2 to about 6 wt. %, about 3 to about 5 wt. %, or about 4 wt. % based on a total weight of the High S. In some embodiments, the High S has a specific gravity of about 0.92 to about 0.94, such as about 0.922 to about 0.938, about 0.924 to about 0.936, about 0.926 to about 0.934, about 0.928 to about 0.932, or about 0.930. In some embodiments, the High S has a specific gravity of about 0.930.

In some embodiments, the vacuum residue (VR) has a weight loss of about 80 to 95 wt. %, such as about 85 to about 95 wt. %, about 90 to about 95 wt. %, or about 90 wt. % at a temperature of about 450 to 800° C., such as about 500 to about 700° C., or about 600° C., as determined by TGA and depicted in FIG. 2A. In some embodiments, the VR has a carbon content of about 4 to about 15 wt. %, such as about 6 to about 12 wt. %, about 8 to about 10 wt. %, about 8.5 to about 9.5 wt. %, or about 9 wt. %, based on the total weight of the VR, as depicted in FIG. 2B. In some embodiments, the VR has a carbon number of about 30 to about 80, such as about 40 to about 70, about 50 to about 60, or about 55, as depicted in FIG. 2C. In some embodiments, the VR has a DBE value of about 3 to 30, such as about 5 to about 25, about 7 to about 20, or about 9 to about 15, as depicted in FIG. 2D.

In some embodiments, the Arab light crude oil (hereafter referred to as “AR” or “AL”) has a specific gravity of about 0.88 to about 0.90, such as about 0.882 to about 0.898, about 0.884 to about 0.896, about 0.886 to about 0.894, about 0.888 to about 0.892, or about 0.890. The AR (or AL) is straight Arab light crude without any processing or refining. In some embodiments, the AR has a carbon content of about 0.1 to about 8 wt. %, such as about 0.3 to about 6 wt. %, about 0.5 to about 4 wt. %, about 0.7 to about 2 wt. %, or about 0.9 to 1 wt. %, based on the total weight of the AR, as depicted in FIG. 2B. In some embodiments, the AL has a carbon number of about 4to about 40, such as about 5 to about 30, about 6 to about 20, or about 7 to about 10, as depicted in FIG. 2C. In some embodiments, the AL has a DBE value of about 0 to 15, such as about 0 to about 10, about 1 to about 5, or about 2 to about 3, as depicted in FIG. 2D.

In some embodiments, the one or more metal salts are compounds having a formula X-Y, in which X is a metal cation selected from the group consisting of potassium, calcium, and sodium, and Y is an anion selected from the group consisting of fluoride, chloride, bromide, acetate oxalate, carbonate, and bicarbonate. In further embodiments, the one or more metal salts include, but are not limited to, potassium carbonate, potassium bicarbonate, potassium chloride, calcium carbonate, calcium bicarbonate, calcium chloride, sodium carbonate, sodium bicarbonate, and 25sodium chloride. In some embodiments, the one or more metal salts are potassium carbonate and potassium chloride. In some embodiments, the one or more metal salts are potassium carbonate.

In some embodiments, a weight ratio of the one or more petroleum feedstocks and the one or more metal salts is in a range of about 10:1 to about 1:2, such as about 9:1 to about 1:1, about 8:1 to about 1:1, about 7:1 to about 1:1, about 6:1 to about 1:1, about 5:1 to about 1:1, about 4:1 to about 1:1, about 3:1 to about 1:1, about 2:1 to about 1:1, or about 1:1. In further embodiments, the weight ratio of the one or more petroleum feedstocks and the one or more metal salts is about 1:1.

In some embodiments, the one or more petroleum feedstocks contain the light cycle oil (LCO), the heavy cycle oil (HCO), the vacuum residue (VR), and the Arab light crude oil (AL or AR). In some embodiments, the LCO is present in the one or more petroleum feedstocks in an amount of about 5 to about 30 wt. %, such as about 7 to about 28 wt. %, about 9 to about 26 wt. %, about 11 to about 24 wt. %, about 13 to about 22 wt. %, about 15 to about 20 wt. %, or about 17 to about 18 wt. %. In further embodiments, the LCO is present in the one or more petroleum feedstocks in the amount of about 25 wt. %.

In some embodiments, the HCO is present in the one or more petroleum feedstocks in an amount of about 5 to about 30 wt. %, such as about 7 to about 28 wt. %, about 9 to about 26 wt. %, about 11 to about 24 wt. %, about 13 to about 22 wt. %, about 15 to about 20 wt. %, or about 17 to about 18 wt. %. In further embodiments, the HCO is present in the one or more petroleum feedstocks in the amount of about 25 wt. %.

In some embodiments, the VR is present in the one or more petroleum feedstocks in an amount of about 5 to about 30 wt. %, such as about 7 to about 28 wt. %, about 9 to about 26 wt. %, about 11 to about 24 wt. %, about 13 to about 22 wt. %, about 15 to about 20 wt. %, or about 17 to about 18 wt. %. In further embodiments, the VR is present in the one or more petroleum feedstocks in the amount of about 25 wt. %.

In some embodiments, the AL is present in the one or more petroleum feedstocks in an amount of about 5 to about 30 wt. %, such as about 7 to about 28 wt. %, about 9 to about 26 wt. %, about 11 to about 24 wt. %, about 13 to about 22 wt. %, about 15 to about 20 wt. %, or about 17 to about 18 wt. %. In further embodiments, the AL is present in the one or more petroleum feedstocks in the amount of about 25 wt. %.

In some embodiments, the one or more petroleum feedstocks contains about 10 wt. % of LCO, about 20 wt. % of HCO, about 30 wt. % of VR, and about 40 wt. % of AL. In some embodiments, the one or more petroleum feedstocks contains about 40 wt. % of LCO, about 30 wt. % of HCO, about 20 wt. % of VR, and about 10 wt. % of AL. In some embodiments, the one or more petroleum feedstocks contains about 50 wt. % of LCO, about 20 wt. % of HCO, about 20 wt. % of VR, and about 10 wt. % of AL. In some embodiments, the one or more petroleum feedstocks contains about 60 wt. % of LCO, about 10 wt. % of HCO, about 20 wt. % of VR, and about 10 wt. % of AL. In some embodiments, the one or more petroleum feedstocks contains about 70 wt. % of LCO, about 10 wt. % of HCO, about 10 wt. % of VR, and about 10 wt. % of AL. In some embodiments, the one or more petroleum feedstocks contains about 25 wt. % of LCO, about 25 wt. % of HCO, about 25 wt. % of VR, and about 25 wt. % of AL.

The method of preparing the NPC material further includes calcining the mixture at a temperature of about 400 to about 800° C. in an inert atmosphere to form a crude material; and washing the crude material and drying. In some embodiments, the mixture is calcined at a temperature of about 450 to about 750° C., such as about 500 to about 700° C., about 550 to about 650° C., or about 600° C. in the inert atmosphere. In further embodiments, the mixture is calcined at a temperature of about 600 to about 700° C. in the inert atmosphere. In some embodiments, the crude product is washed by water for at least 2 times, such as at least 4 times, at least 8 times, or at least 16 times until the one or more metal salts are removed from the crude material, thereby forming a washed material and a wash solution containing the one or more metal salts. In some embodiments, the washed material is dried using heating appliances such as ovens, microwaves, autoclaves, hot plates, heating mantles and tapes, oil baths, salt baths, sand baths, air baths, hot-tube furnaces, and hot-air guns, at a temperature of about 60 to about 120° C., such as about 70 to about 110° C., about 80 to about 100° C., or about 90 to about 100° C., to remove the water and regenerate the one or more metal salts.

### EXAMPLES

The following examples demonstrate methods for harvesting water using a nanoporous carbon (NPC) material, as described herein. The examples are provided solely for illustration and are not to be construed as limitations of the present disclosure, as many variations thereof are possible without departing from the spirit and scope of the present disclosure.

### Example 1: General Procedure

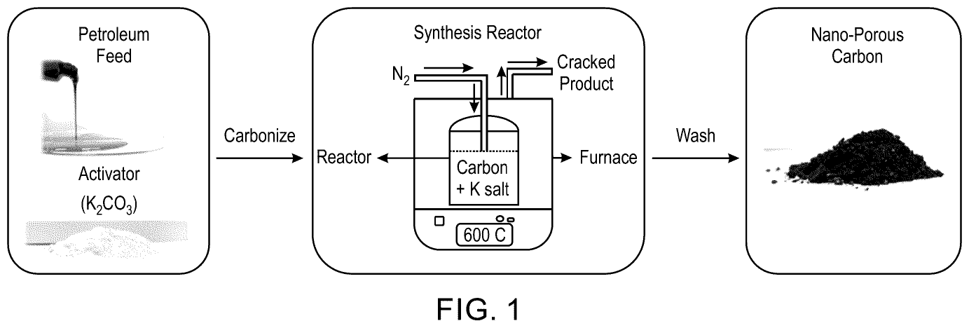

The NPC materials were prepared using one or more petroleum feedstocks and/or combined with one or more metal salts, followed by carbonization. The selected petroleum feedstocks are readily available and can be obtained from low-value streams of a refinery. Furthermore, one or more petroleum feedstocks were tested to characterize their abilities and explore their applications in the carbonization route for converting crude oil into solid carbon. The carbonization reaction was performed under a nitrogen atmosphere at a heating temperature of about 600° C. to prevent the oxidation of nanoporous carbons shown in FIG. 1. The reaction was monitored, and after the reaction was completed, it was washed with water to remove the metal salts from the NPC material. The NPC material was then dried in an oven for overnight to remove residual water. On the other hand, the wash solution containing the washed water and the metal salts was heated to evaporate water from the wash solution, thereby regenerating the metal salts to be recovered for future use.

### Example 2: Preparation of the Nanoporous Carbon (NPC) Materials in the Presence of Metal Salts

The NPC material was prepared using light cycle oil (LCO), the heavy cycle oil (HCO), the vacuum residue (VR), the Arab light crude oil (AL or AR) in the presence of potassium carbonate, followed by carbonization. The selected petroleum feedstocks have a fixed carbon content of less than about 10 wt. %. The selected petroleum feedstocks and potassium carbonate were mixed to form a mixture, which was then subjected to the carbonization reaction. The carbonization reaction was conducted under a nitrogen atmosphere at a heating temperature of about 600° C. The potassium carbonate was recovered from the washed solution of the reaction product according to the procedure provided in the present disclosure. Properties of the selected petroleum feedstocks are shown in Table 1 below.

TABLE 1
Properties of the selected petroleum feeds

| | Specific gravity | Sulfur content. | Boiling range* |
|---|---|---|---|
| Feed name | @ 15° C. | (wt. %) | (° C.) |
| Light cycle oil (LCO) | 0.9 | 0.2 | 50-200 |
| Heavy cycle oil (HCO) | 1.09 | 0.6 | 80-410 |
| Arab light (AL) | 0.8 | 0.8 | 30-560 |
| Vacuum residue (VR) | 1.01 | 2.97 | 240-530 |

*Boling range was taken from the initial boing point to the final boiling point from TGA curves.

### Example 3: Preparation of the Nanoporous Carbon (NPC) Materials in the Absence of Metal Salts

The NPC material was prepared using light cycle oil (LCO), the heavy cycle oil (HCO), the vacuum residue (VR), and the Arab light crude oil (AL or AR). The carbonization reaction was performed under a nitrogen atmosphere at a heating temperature of about 600° C.

### Example 4: Characterization of the Petroleum Feedstocks

Thermogravimetric analysis (TGA) tests were performed to characterize the selected petroleum feedstocks without the presence of metal salts as carbonization agents, as shown in FIG. 2A. The selected petroleum feedstocks include, but are not limited to, LCO, HCO, VR, and AL (also referred to as AR). FIG. 2B illustrates that the selected petroleum feedstocks have less than about 10 wt. % of fixed carbon content. Additionally, the carbon content of the petroleum feedstocks is lower than that of biomass, such as oil palm fronds, dry leaves, and coconut shells, as depicted in FIG. 2B. The carbonization agent promotes the formation of nanoporous carbon during the carbonization process, compared to the thermal cracking method of producing a carbon material. FIG. 2C shows carbon number distributions of the selected petroleum feedstocks. The dots in FIG. 2C represent the weight average values of the carbon number of the petroleum feedstocks, respectively. FIG. 2D shows double bond equivalent (DBE) values of the selected petroleum feedstocks. The dots in FIG. 2D represent the weight average values of the DBE of the petroleum feedstocks, respectively.

### Example 5: Characterization of the NPC Materials

The thermal stability of NPC materials was tested under both air and inert atmosphere conditions. The results showed that the NPC materials are stable in a N₂ atmosphere. No substantial weight loss or chemical degradation were observed at a temperature of up to 600° C. However, when exposed to atmospheric air, the NPC material began decomposing at about 400° C., as depicted in FIG. 3A. The XRD results of the NPC materials show a broad peak at (002), attributed to the enhanced porous morphology of the nanoporous carbon, as depicted in FIG. 3B. Raman spectrum of the NPC materials shows amorphous carbon with strong D band attributed to the presence of edges and defects, as depicted in FIG. 3C. The environmental scanning electron microscope (ESEM) image of the obtained NPC material shows a sponge-like texture with pores covering surfaces of the nanoporous carbon, as depicted in FIG. 3D.

The surface properties of the NPC materials were examined using water contact angle measurement. As depicted in FIG. 4A, a water droplet remains intact before contacting with the NPC material. After the contacting, the water contact angle on the surface of the NPC material is zero, as shown in FIG. 4B, indicating the super-hydrophilic surface property of the NPC material. This is attributed to the presence of large amount of oxygen on surfaces of the nanoporous carbon, resulting in hydrophilic surface behavior, as determined by the EDX analysis and depicted in FIG. 4C.

### Example 6: Water Adsorption Test

Water adsorption test was conducted on the NPC materials to examine their applications as solid adsorbents. The NPC material was first placed on a tray. The tray was then transferred into a container filled with a sea water solution, and floated on the sea water solution. The container was then covered with a lid to form a closed atmosphere. The NPC material was allowed to saturate and absorb water from the surrounding air before heating the sorbent to release the adsorbed water, as shown in FIG. 5A.

FIG. 5B shows a FTIR spectrum of the NPC material before and after exposure to moisture. When exposed to moisture, the nanoporous carbon showed a broad OH signal occurring at 3300 cm⁻¹ corresponding to OH stretching of the adsorbed water. The broadness of the peak is attributed to the formation of hydrogen bonds between the nanoporous carbon and the adsorbed water. Once saturated, the sorbent was heated to remove moisture and the amount of water adsorbed was observed as a drop-in weight. The nanoporous carbon, based on the precursor feeds, was observed to have a capacity that can reach up to about 22 wt. % when exposed to about 60% RH. The water uptake capacity was found to surpass that of activated carbon (AC) and carbon black (CB) as shown in FIG. 5C. Wight loss was attributed to moisture loss as determined by the temperature programmed desorption (TPD) method. FIG. 5D shows that the maximum weight loss of water occurred at about 150° C.

### EMBODIMENTS

Certain embodiments of this disclosure can be implemented as a method for harvesting water. A nanoporous carbon (NPC) material is contacted with a stream of humid atmospheric air, thereby at least partially absorbing water in the form of molecules on surfaces and pores of the NPC material to form a sample. The NPC material is prepared from one or more petroleum feedstocks selected from the group consisting of a pyrolysis oil, a light cycle oil, a heavy cycle oil, a high sulfur containing residue, a vacuum residue, an Arab light crude oil, an Arab extra light crude oil, and mixtures thereof. The water is released from the sample by thermally heating the sample or exposing the sample to ultraviolet-visible (UV-Vis) radiation, and then the water is collected.

An aspect combinable with any other aspect can include the following features. The NPC material is in contact with the stream at ambient conditions of room temperature and atmospheric pressure.

An aspect combinable with any other aspect can include the following features. The stream of humid atmospheric air has a relative humidity (RH) of about 15 to about 80% based on a maximum pressure of water vapor present in the humid atmospheric air.

An aspect combinable with any other aspect can include the following features. The NPC material contains about 70 to about 90 wt. % of carbon, about 2 to about 20 wt. % of oxygen, and about 0.001 to about 7 wt. % of one or more alkali metals and alkali earth metals.

An aspect combinable with any other aspect can include the following features. The one or more alkali metals and alkali earth metals are selected from the group consisting of lithium, sodium, potassium, rubidium, cesium, francium, beryllium, magnesium, calcium, strontium, barium, radium, and mixtures thereof.

An aspect combinable with any other aspect can include the following features. The NPC material contains about 85.5 wt. % of carbon, about 14 wt. % of oxygen, and about 0.5 wt. % of potassium.

An aspect combinable with any other aspect can include the following features. The NPC material has a water contact angle of less than about 2 degrees (°).

An aspect combinable with any other aspect can include the following features. The NPC material has a water uptake capacity of about 3 to about 50 wt. % of the NPC material.

An aspect combinable with any other aspect can include the following features. The NPC material has a weight loss of less than about 5 wt. % of the NPC material in an inert atmosphere at a temperature of about 600° C.

An aspect combinable with any other aspect can include the following features. The NPC material has an average pore size of about 50 nanometers (nm) to about 1000 nm.

An aspect combinable with any other aspect can include the following features. The sample is thermally heated at a temperature of about 30 to about 600° C.

An aspect combinable with any other aspect can include the following features. The sample has a maximum weight loss of water at a temperature of about 150° C. as determined by a temperature programmed desorption (TPD) method.

An aspect combinable with any other aspect can include the following features. The sample is exposed to UV-Vis radiation at a wavelength of about 150 to about 600 nm.

An aspect combinable with any other aspect can include the following features. The NPC material is prepared. A mixture is first formed by mixing the one or more petroleum feedstocks and one or more metal salts. The mixture is calcined at a temperature of about 400 to about 800° C. in an inert atmosphere to form a crude material. The crude material is washed and dried.

An aspect combinable with any other aspect can include the following features. The one or more metal salts are compounds having a formula X-Y, in which X is a metal cation selected from the group consisting of potassium, calcium, and sodium, and Y is an anion selected from the group consisting of fluoride, chloride, bromide, acetate oxalate, carbonate, and bicarbonate.

An aspect combinable with any other aspect can include the following features. The one or more metal salts are potassium carbonate.

An aspect combinable with any other aspect can include the following features. A weight ratio of the one or more petroleum feedstocks and the one or more metal salts is in a range of about 10:1 to about 1:2.

An aspect combinable with any other aspect can include the following features. The weight ratio of the one or more petroleum feedstocks and the one or more metal salts is about 1:1.

An aspect combinable with any other aspect can include the following features. The mixture is calcined at a temperature of about 600 to about 700° C. in the inert atmosphere.

An aspect combinable with any other aspect can include the following features. The one or more petroleum feedstocks include the light cycle oil (LCO), the heavy cycle oil (HCO), the vacuum residue (VR), and the Arab light crude oil (AL). The LCO is present in the one or more petroleum feedstocks in an amount of about 5 to about 30 wt. %. The HCO is present in the one or more petroleum feedstocks in an amount of about 5 to about 30 wt. %. The VR is present in the one or more petroleum feedstocks in an amount of about 5 to about 30 wt. %. The AL is present in the one or more petroleum feedstocks in an amount of about 5 to about 30 wt. %.

When describing the present disclosure, the terms used are to be construed in accordance with the following definitions, unless a context dictates otherwise. Embodiments of the present invention will now be described more fully hereinafter with reference to the accompanying drawings wherever applicable, in that some, but not all embodiments of the disclosure are shown.

Unless otherwise defined, all technical and scientific terms used in this document have the same meaning as commonly understood by one of ordinary skill in the art to which the present application belongs. Methods and materials are described in this document for use in the present application; other, suitable methods and materials known in the art can also be used. The materials, methods, and examples are illustrative only and not intended to be limiting.

In the drawings, like reference numerals designate identical or corresponding parts throughout the several views. As used in this disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, and 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about,” as used in this disclosure, can allow for a degree of variability in a value or range, for example, within 10%, within 5%, or within 1% of a stated value or of a stated limit of a range.

As used herein, the terms “particle size” and “pore size” are thought of as the lengths or longest dimensions of a particle and of a pore opening, respectively.

As used herein, the terms “room temperature” or “ambient temperature” refer to a temperature in a range of 25 degrees Celsius (° C)±3° C. in the present disclosure.

As used herein, the term “atmospheric pressure” refers to the pressure exerted by the weight of air in the atmosphere of Earth. The standard atmosphere is a unit of pressure defined as about 101325 Pa (or about 1.01325 bar), equivalent to about 760 mmHg (torr), or about 29.92 in Hg and about 14.696 psi in the present disclosure.

As used herein, the term “hydrophilic” surface generally refers to surfaces that have a contact angle from about 40 to about 90° with a droplet of water, such as about 45 to about 85°, about 50 to about 80°, about 55 to about 80°, about 55 to about 75°, about 60 to about 70°, or about 65°.

As used herein, the term “super-hydrophilic” surface generally refers to surfaces that have a contact angle from about 0 to about 40° with a droplet of water, such as about 0 to about 35°, about 0 to about 30°, about 0 to about 25°, about 0 to about 20°, about 0 to about 15°, about 0 to about 10°, about 0 to about 5°, or about 0 to about 2°.

As used herein, the term “uniform shape” refers to an average consistent shape that differs by no more than about 10%, such as by no more than about 5%, by no more than about 4%, by no more than about 3%, by no more than about 2%, or by no more than about 1% of the distribution of particles having a different shape.

As used herein, the term “non-uniform shape” refers to an average consistent shape that differs by more than about 10%, such as more than about 15%, more than about 20%, or more than about 30% of the distribution of particles having a different shape.

As used herein, the term “inert atmosphere” refers to a gaseous environment that includes non-reactive gases (i.e., that do not decompose under the action of UV) such as, for example, Ar, He, Xe, Kr, N₂, and Ar.

As used herein, the term “crude oil” refers to petroleum extracted from geologic formations in its unrefined form. Crude oil suitable as the source material for the processes herein include Arabian Heavy, Arabian Light, Arabian Extra Light, other Gulf crudes, Brent, North Sea crudes, North and West African crudes, Indonesian, Chinese crudes, or mixtures thereof. The crude petroleum mixtures can be whole range crude oil or topped crude oil. As used herein, “crude oil” also refers to such mixtures that have undergone some pre-treatment such as water-oil separation; and/or gas-oil separation; and/or desalting; and/or stabilization. In certain cases, crude oil refers to any of such mixtures having an API gravity (ASTM D287 standard), of greater than or equal to about 20°, 30°, 32°, 34°, 36°, 38°, 40°, 42° or 44°.

As used herein, Arab extra light crude oil is characterized by an API gravity of greater than or equal to about 38°, 40°, 42° or 44°, and in certain cases in the range of about 38°-46°, 38°-44°, 38°-42°, 38°-40.5°, 39°-46°, 39°-44°, 39°-42° or 39°-40.5°.

As used herein, Arab light crude oil (acronym “AL” or “AR”) is characterized by an API gravity of greater than or equal to about 30°, 32°, 34°, 36° or 38°, and in certain cases in the range of about 30°-38°, 30°-36°, 30°-35°, 32°-38°, 32°-36°, 32°-35°, 33°-38°, 33°-36° or 33°-35°.

As used herein, the term “vacuum residue” and its acronym “VR” as used herein refer to the bottom hydrocarbons having an initial boiling point corresponding to the end point of the vacuum gas oil range hydrocarbons, and having an end point based on the characteristics of the crude oil feed. The term “vacuum gas oil” and its acronym “VGO” as used herein refer to hydrocarbons boiling in the range of about 370-550, 370-540, 370-530, 370-510, 400-550, 400-540, 400-530, 400-510, 420-550, 420-540, 420-530 or 420-510° C.

The terms “pyrolysis oil” and its abbreviated form “pyoil” are used herein having their well-known meaning, that is, a heavy oil fraction, C10+, that is derived from steam cracking.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

In the methods described in this disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

1. A method for harvesting water, comprising:
contacting a nanoporous carbon (NPC) material with a stream of humid atmospheric air, thereby at least partially absorbing water in the form of molecules on surfaces and pores of the NPC material to form a sample, wherein the NPC material is prepared from one or more petroleum feedstocks selected from the group consisting of a pyrolysis oil, a light cycle oil, a heavy cycle oil, a high sulfur containing residue, a vacuum residue, an Arab light crude oil, an Arab extra light crude oil, and mixtures thereof;
releasing the water from the sample by thermally heating the sample or exposing the sample to ultraviolet-visible (UV-Vis) radiation; and
collecting the water.

2. The method of claim 1, wherein the NPC material is in contact with the stream at ambient conditions of room temperature and atmospheric pressure.

3. The method of claim 1, wherein the stream of humid atmospheric air has a relative humidity (RH) of about 15 to about 80% based on a maximum pressure of water vapor present in the humid atmospheric air.

4. The method of claim 1, wherein the NPC material comprises about 70 to about 90 wt. % of carbon, about 2 to about 20 wt. % of oxygen, and about 0.001 to about 7 wt. % of one or more alkali metals and alkali earth metals.

5. The method of claim 4, wherein the one or more alkali metals and alkali earth metals are selected from the group consisting of lithium, sodium, potassium, rubidium, cesium, francium, beryllium, magnesium, calcium, strontium, barium, radium, and mixtures thereof.

6. The method of claim 4, wherein the NPC material comprises about 85.5 wt. % of carbon, about 14 wt. % of oxygen, and about 0.5 wt. % of potassium.

7. The method of claim 1, wherein the NPC material has a water contact angle of less than about 2 degrees (°).

8. The method of claim 1, wherein the NPC material has a water uptake capacity of about 3 to about 50 wt. % of the NPC material.

9. The method of claim 1, wherein the NPC material has a weight loss of less than about 5 wt. % of the NPC material in an inert atmosphere at a temperature of about 600° C.

10. The method of claim 1, wherein the NPC material has an average pore size of about 50 nanometers (nm) to about 1000 nm.

11. The method of claim 1, wherein the thermally heating the sample is carried out at a temperature of about 30 to about 600° C.

12. The method of claim 11, wherein the sample has a maximum weight loss of water at a temperature of about 150° C. as determined by a temperature programmed desorption (TPD) method.

13. The method of claim 1, wherein the exposing the sample to UV-Vis radiation is carried out at a wavelength of about 150 to about 600 nm.

14. The method of claim 1, further comprising preparing the NPC material by:
mixing the one or more petroleum feedstocks and one or more metal salts to form a mixture;
calcining the mixture at a temperature of about 400 to about 800° C. in an inert atmosphere to form a crude material; and
washing the crude material and drying.

15. The method of claim 14, wherein the one or more metal salts are compounds having a formula X-Y, wherein X is a metal cation selected from the group consisting of potassium, calcium, and sodium, and wherein Y is an anion selected from the group consisting of fluoride, chloride, bromide, acetate oxalate, carbonate, and bicarbonate.

16. The method of claim 15, wherein the one or more metal salts are potassium carbonate.

17. The method of claim 14, wherein a weight ratio of the one or more petroleum feedstocks and the one or more metal salts is in a range of about 10:1 to about 1:2.

18. The method of claim 17, wherein the weight ratio of the one or more petroleum feedstocks and the one or more metal salts is about 1:1.

19. The method of claim 14, wherein the mixture is calcined at a temperature of about 600 to about 700° C. in the inert atmosphere.

20. The method of claim 14, wherein the one or more petroleum feedstocks comprise the light cycle oil (LCO), the heavy cycle oil (HCO), the vacuum residue (VR), and the Arab light crude oil (AL), wherein the LCO is present in the one or more petroleum feedstocks in an amount of about 5 to about 30 wt. %, wherein the HCO is present in the one or more petroleum feedstocks in an amount of about 5 to about 30 wt. %, wherein the VR is present in the one or more petroleum feedstocks in an amount of about 5 to about 30 wt. %, and wherein the AL is present in the one or more petroleum feedstocks in an amount of about 5 to about 30 wt. %.
